(19) United States
(12) Patent Application Publication
(10) Pub. No.: US 2019/0374045 A1
(43) Pub. Date: Dec. 12, 2019

(54) INFANT COVER WITH INTEGRATED DISTRACTION OBJECT AND TEETHING OBJECT

(71) Applicant: Naama N. Klatsky, Mill Valley, CA (US)

(72) Inventor: Naama N. Klatsky, Mill Valley, CA (US)

(21) Appl. No.: 16/435,455

(22) Filed: Jun. 7, 2019

Related U.S. Application Data
(60) Provisional application No. 62/682,815, filed on Jun. 8, 2018.

(51) Int. Cl. A47D 13/02; A61J 17/02

(52) U.S. Cl. CPC A47D 13/02; A47D 15/005; A61J 17/02

(57) ABSTRACT

An infant cover having an incorporated distraction object and teething object for covering an infant held in a baby carrier, for example, is described. The cover is equipped with a distraction object and a teething object that are in view of and accessible by the infant and that requires no manipulation or assistance from a caregiver in order for the infant to reach for and hold either object. The attachment means, such as a string or necklace, is used for attaching the cover to the caregiver. The attachment means has one segment extending down one side of the cover and another segment extending down another side of the cover. One of the segments has a distraction object and the other segment has a teething object. The objects are accessible by the infant without assistance from another person, such as the caregiver.

### CROSS-REFERENCE TO RELATED APPLICATIONS

This application claims the benefit under 35 U.S.C. § 119(e) of U.S. Provisional Patent Application No. 62/682,815, filed on Jun. 8, 2018, titled “Infant Cover With Integrated Distraction Object and Teething Object,” which is incorporated by reference herein in its entirety for all purposes.

### BACKGROUND OF THE INVENTION

### Field of the Invention

The present invention relates to infant accessories and clothing. More specifically, it relates to an infant cover having integrated objects for distraction and teething accessible by an infant without assistance from the person carrying the infant.

### Description of the Related Art

Presently, there are many types of covers and accessories for covering infants that can be used with various types of infant and toddler-related equipment. The most common one is a cloth cover that can be used for covering infants while the infant is positioned in a baby carrier that is worn by an individual, typically a parent and in many cases the mother of the infant. Many of the covers that are currently available are too large or, more generally, are not a suitable size. Most of them are comprised simply of cloth (of various types) and have a means for attachment to another object, such as the baby carrier, as noted, a stroller, an infant car seat, or to a person, typically a nursing mother.

However, in addition to size, comfort, and other ergonomic factors, conventional covers for protecting and covering infants and providing privacy for nursing mothers are deficient in at least two functions. One drawback of current covers is that they do not have an integrated distraction object, such as a toy, that an infant can hold and manipulate as a distraction. The covers do not provide such an object as a component of the infant cover. As is known to many parents and caregivers, infants often need a toy or object to hold or handle as a distraction or something to focus on. Another drawback of many infant covers is related to a physiological aspect of infant growth, commonly referred to as teething. Infants often want something to put in their mouths and chew on to alleviate discomfort that comes from emerging teeth. A universal item for infants everywhere is a teething object that they can safely chew on. Current infant covers lack an integrated teething object that, similar to the distraction object, is easily accessible to the infant without assistance from a caregiver while the caregiver is wearing a baby carrier or when the cover is attached to a car seat, stroller, or other equipment.

What is needed is an infant cover that is equipped with a distraction object and a teething object that are in view of and accessible by the infant and that requires no manipulation or assistance from a caregiver in order for the infant to reach for and hold either object. It would also be preferable that the cover be of a suitable size depending on the context and manner in which it is being used.

### SUMMARY OF THE EMBODIMENTS

An infant cover having an incorporated distraction object and teething object, said cover for covering an infant held in a baby carrier, in a stroller, in an infant car seat, or held in another object is described. The cover is equipped with a distraction object and a teething object that are in view of and accessible by the infant and that requires no manipulation or assistance from a caregiver in order for the infant to reach for and hold either object.

The attachment means, such as a string or necklace, is used for attaching the cover to an entity, including those noted above or a caregiver. The attachment means has one segment extending down one side of the cover and another segment extending down another side of the cover. One of the segments has a distraction object and the other segment has a teething object. The objects are not exposed from under the cover, that is, they are not exposed to the outside, they are kept between the caregiver, for example, and the cover. The objects are accessible by the infant without assistance from another person, such as the caregiver. The cover protects the head and torso of the infant. The attachment means may hold multiple decorative objects and one of the objects may be removed and used to replace one of the teething or distraction objects, or both.

### BRIEF DESCRIPTION OF THE DRAWINGS

References are made to the accompanying drawings, which form a part of the description and in which are shown, by way of illustration, specific embodiments of the present invention:

FIG. 1 is a perspective drawing illustrating how an infant cover may be utilized in accordance with one embodiment;

FIG. 2 is an illustration showing one side of a cover in accordance with one embodiment; and

FIG. 3 is an illustration showing another side of a cover in accordance with one embodiment.

### DETAILED DESCRIPTION OF THE INVENTION

Example embodiments of an infant cover with integrated distraction and teething objects are described in the various figures. These examples and embodiments are provided solely to add context and aid in the understanding of the invention. Thus, it will be apparent to one skilled in the art that the present invention may be practiced without some or all of the specific details described herein. In other instances, well-known concepts have not been described in detail in order to avoid unnecessarily obscuring the present invention. Other applications and examples are possible, such that the following examples, illustrations, and contexts should not be taken as definitive or limiting either in scope or setting. Although these embodiments are described in sufficient detail to enable one skilled in the art to practice the invention, these examples, illustrations, and contexts are not limiting, and other embodiments may be used and changes may be made without departing from the spirit and scope of the invention.

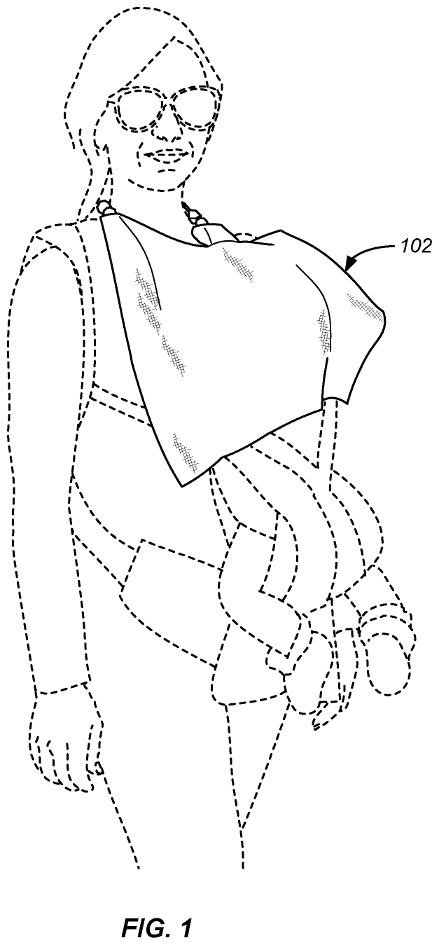

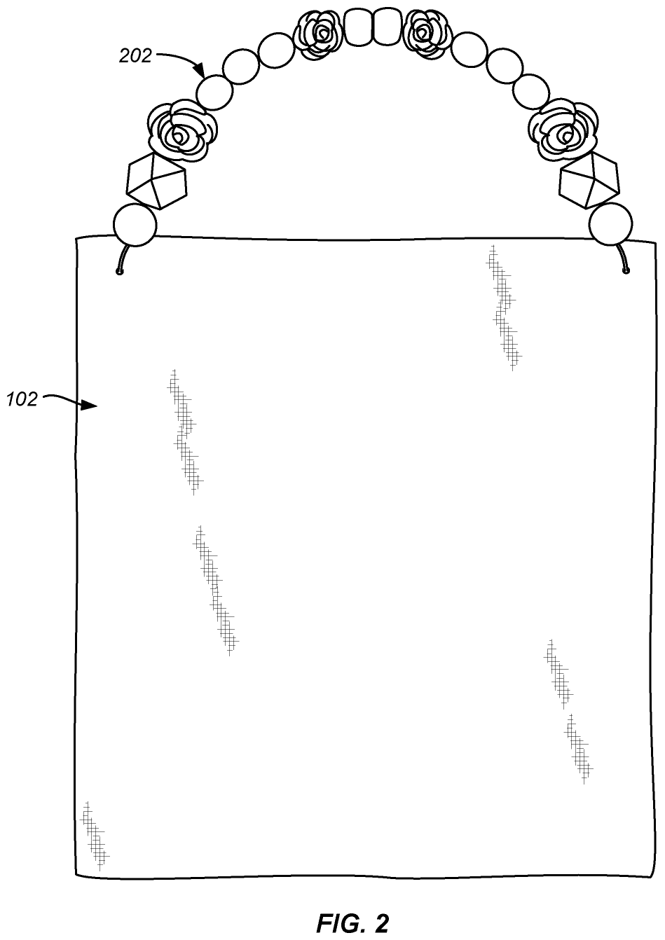

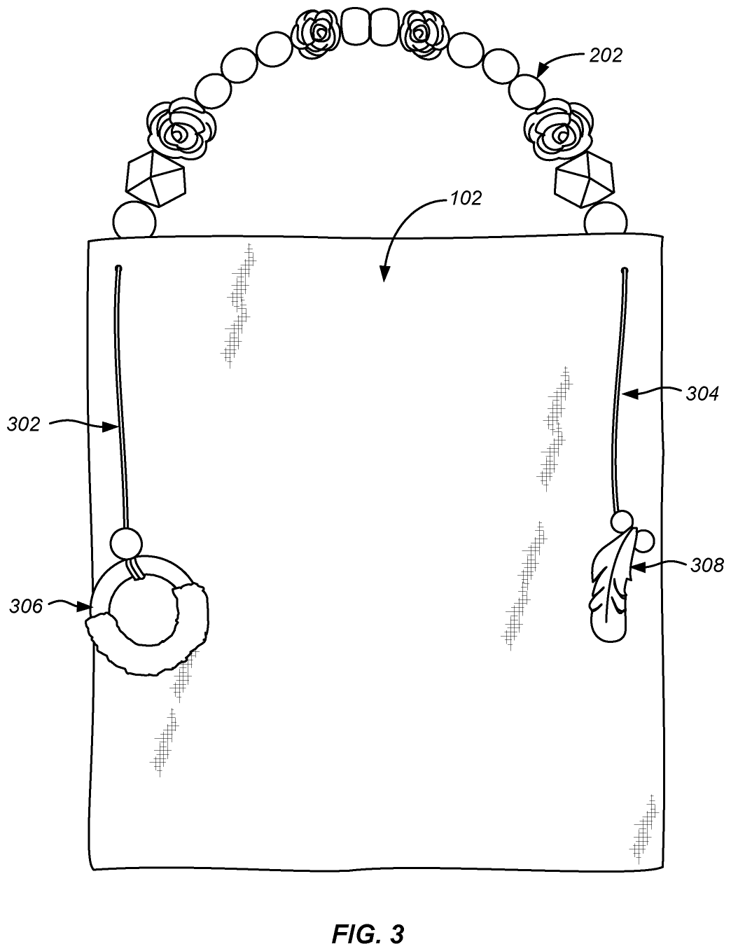

An infant cover that can be used in various ways having a distraction component and a teething component as part of the cover is described in the figures. FIG. 1 is a perspective drawing illustrating how an infant cover may be utilized in accordance with one embodiment. A person holding an infant in a conventional baby carrier is wearing a cover 102 to cover the head and torso of an infant. The length, width, and other dimensions of cover 102 may vary depending on how or in what context the cover is being used. In one embodiment, cover 102 is made of two layers of fabric, such as Muslin, fused together, providing a soft and breathable fabric. In other embodiments, the material may be another suitable substance or combination of materials. As can be partially seen in FIG. 1, and as described in more detail in FIGS. 2 and 3, an attachment means, such as a string or necklace, is part of cover 102 and goes around the neck of the person wearing the baby carrier.

FIG. 2 is an illustration showing one side of cover 102 in accordance with one embodiment. The side shown here may be described as the outward facing side, the side that is exposed to the public (the side shown in FIG. 1). An attachment means 202 may be described as a necklace component that goes around a person's neck or be put around a suitable nearby object to hold cover 102 in place. Necklace component 202 is comprised of a string with decorative objects attached to it. The string goes through two holes as shown, one near both upper corners of cover 102. The string (or similar material) may slide or move through the apertures, for example button holes, to adjust to a person's neck or to whatever object is being used to hold cover 102. As noted, the dimensions of cover 102 as shown in this embodiment is a rectangle, however, other dimensions and shapes may be used.

FIG. 3 is an illustration showing another side of cover 102 in accordance with one embodiment. This side may be described as the inward facing surface that is in contact with the infant. Attachment means or necklace 202 is shown with the same decorative elements but from the reverse side as that of FIG. 2. The two apertures are in the same locations. The string component of the necklace extends down the sides of cover 102. This is shown as string segments 302 and 304. The length of these segments may vary depending on how cover 102 is being used, the size of the infant, safety factors, and the like. As noted, this is the side that the infant is exposed to. The infant may be facing the surface (that is, the infant is facing away from the caregiver) or the infant is facing the caregiver and the back of the infant's head is in contact with the cover.

In either scenario, the infant is able to reach over without assistance from the caregiver and on either side, grab string segment 302 or 304. At the end of segment 302 is a distraction object or toy 306 that is attached to the end of necklace 202. At the end of segment 304 is a teething object 308 that is attached to the other end of necklace 202. This object is made from a safe, known teething material. In other embodiments, a wide variety of objects can be used as toy 306 and any suitably sized and safe teething object can be used in place of object 308. The infant has unobstructed access to objects 306 and 308 while cover 102 is in use. This unobstructed access allows the infant to see, reach for, and grip onto objects 306 or 308. This allows the caregiver to focus on other activities. It frees the caregiver to not have to stop whatever he or she is doing and help the infant.

Generally, it is expected that objects 306 and 308 will not be exposed to the outside of cover 102. In some embodiments, the caregiver may attachment different types of objects at the end of segments 302 and 304. For example, they can both be teething object or distraction objects. The caregiver can adjust the size of the loop or arch formed by necklace 202 when putting on or taking off cover 102. In other embodiments, some or all of the decorative elements on necklace 202 may be teething objects and used in the same function as teething object 308. Some may also be a distraction object. Although the objects or elements on necklace 202 may be decorative, they need not be. In one embodiment, it is desirable to collectively make the individual decorative elements a fashion accessory for the caregiver, in many cases the infant's mother. In another embodiment, a decorative element can be removed from necklace 202 and placed as object 306 or object 308 (after removing the object that is currently performing that function).

In this manner, the caregiver can cover the infant whether in a baby carrier, stroller, car seat, crib, and the like without having to find and provide teething objects or toys for the infant given that these objects are integrated with the infant cover.

It is to be understood that the present disclosure is not to be limited to the specific examples illustrated and that modifications and other examples are intended to be included within the scope of the appended claims. Moreover, although the foregoing description and the associated drawings describe examples of the present disclosure in the context of certain illustrative combinations of elements, it should be appreciated that different combinations of elements may be provided by alternative implementations without departing from the scope of the appended claims.

What is claimed is:

1. An infant cloth cover for covering an infant, the cloth cover comprising:
an attachment means for attaching the cover to an entity, wherein the attachment means has a first segment extending down a first side of cover and a second segment extending down a second side of the cover;
a first object at a first end of the first segment of the attachment means;
a second object at a second end of the second segment of the attachment means
wherein first object and second object are not exposed from under the cover; and
wherein the first object and the second object are accessible by the infant without assistance from the entity.

2. An infant cloth cover as recited in claim 1 wherein the cover protects the head and the torso of the infant.

3. An infant cloth cover as recited in claim 1 wherein the first object is a distraction object and the second object is a teething object.

4. An infant cloth cover as recited in claim 1 wherein the entity is a caregiver, stroller, or an infant car seat.

5. An infant cloth cover as recited in claim 1 wherein the attachment means holds a plurality of decorative objects and wherein a decorative object is removed and used as a replacement for the first object or of the second object.
